(19) United States
(12) Patent Application Publication
(10) Pub. No.: US 2019/0164306 A1
(43) Pub. Date: May 30, 2019

(54) Method and Apparatus For Map Constructing And Map Correcting Based On Light-Emitting Device

(71) Applicant: GUANGZHOU AIROB ROBOT TECHNOLOGY CO., LTD., Guangzhou (CN)

(72) Inventor: Beichen Li, Guangzhou (CN)

(21) Appl. No.: 16/262,162

(22) Filed: Jan. 30, 2019

Related U.S. Application Data
(63) Continuation of application No. PCT/CN2016/095960, filed on Aug. 19, 2016.

(51) Int. Cl. G06T 7/579; G01C 21/20; G06T 7/80; H04N 5/225

(52) U.S. Cl. CPC G06T 7/579; G01C 21/206; G06T 2207/10152; H04N 5/2256; G06T 7/80

(57) ABSTRACT

A method for map constructing based on light-emitting device, includes taking a position of a mobile electronic device as a coordinate origin of a map coordinate system, when a center of a spot mark directly emitted by a first light-emitting device and collected by a camera of a mobile electronic device coincides with central point of CCD/CMOS, and recording information of the spot mark of the first light-emitting device and corresponding coordinate values; moving the mobile electronic device with the coordinate origin as a starting point to traverse the entire to-be-localized area, calculating and recording coordinate values of a position of one of obstacles each time when it is detected by the mobile electronic device during the traversing process; and constructing a map based on recorded information of spot mark and corresponding coordinate values and the coordinate values of the position of each said obstacle.

### CROSS-REFERENCE TO RELATED APPLICATIONS

The present application is a Continuation Application of PCT application No. PCT/CN2016/095960 filed on Aug. 19, 2016, the contents of which are hereby incorporated by reference.

### FIELD OF THE INVENTION

The present invention relates to the simultaneous localization and mapping field, more particularly to method and apparatus for map constructing/map correcting based on light-emitting device.

### BACKGROUND OF THE INVENTION

The localization and mapping of mobile electronic devices is a hot spot in the field of robot. There has been a practical solution to the self-localization of mobile electronic devices in known environments and mapping with known locations of robots. However, in many environments the mobile electronic device can't be localized by using global location system, moreover it is difficult or even impossible to obtain the map of the mobile electronic device's working environment in advance. Hence the mobile electronic device needs to build the map in a completely unknown environment under the condition that its position is uncertain, and use the map to locate and navigate autonomously. This is so-called simultaneous localization and mapping (SLAM).

According to the simultaneous localization and mapping (SLAM), the mobile electronic device identifies characteristic indications in an unknown environment by utilizing sensors in the mobile electronic device, and the global coordinates of the mobile electronic device and the characteristic indications are estimated according to the relative position between the mobile electronic device and the characteristic indication and the reading of the encoder.

So far, the most common exiting positioning techniques of automatic walking robots or devices are:

(1) GPS positioning: the basic principle of GPS positioning is based on instantaneous position of the satellite moving with high speed as a known starting data, and using the method of spatial distance resection to determine the location of the point to be measured.

(2) bar code positioning mode: To convert the bar code compiled according to certain rules into meaningful information, it is necessary to go through two processes of scanning and decoding. The color of the object is determined by the type of light it reflects, the white object can reflect the visible light of various wavelengths, the black object absorbs the visible light of various wavelengths, so when the light emitted by the bar code scanner light is reflected on the bar code, the reflected light is irradiated to the photoelectric converter within the bar code scanner, and the photoelectric converter converts reflected light signal into the corresponding electrical signal on the basis of different strength of the reflected light signal. According to difference principles, the scanner can be divided into three types: light pen, CCD and laser. After being output to the amplifying circuit enhancement signals of the bar-code scanner, the electric signals are transmitted to the shaping circuit to convert the analog signals into digital signals. The width of the black bars and black bars are different, hence the duration of the corresponding electrical signals is different. Then the decoder determines the number of bars and nulls by measuring the number of pulse digital electrical signals 0f 0 and 1. The width of the bar and the empty is determined by measuring the duration of the 0, 1 signal. But the obtained data is still chaotic, in order to know the information contained in the bar code, it is necessary to convert the bar symbol into the corresponding number information and character information based on the corresponding coding rules (such as: EAN-8 yards). Finally, the details of the items will be identified through data processing and management by computer system.

The positioning technique above applied in automatic walking robot or automatic walking equipment is relatively complex, each with different shortcomings:

1. GPS positioning is not practical due to signal problems in the room.

2. The bar code positioning mode is limited in usage occasions due to the fact that the bar codes are easily polluted and can't be read.

Positioning and navigation technique of the mobile robot in the indoor environment has the characteristics of high precision and complicated environment for positioning, so the methods above are not applicable.

### SUMMARY OF THE INVENTION

The present invention aims to provide method and apparatus for map constructing/map correcting based on light-emitting device, which effectively constructs a map with high accuracy.

The present invention provides a method for map constructing based on light-emitting device, wherein the method is applicable for real-time mapping of a to-be-localized area, upper part of the to-be-localized area is provided with light-emitting device and the method comprises steps of:

taking a position of a mobile electronic device which is moving along a certain trajectory as a coordinate origin of a map coordinate system, when a center of a spot mark directly emitted by a first light-emitting device and collected by a camera of a mobile electronic device coincides with central point of CCD/CMOS, and recording information of the spot mark of the first light-emitting device and corresponding coordinate values;

moving the mobile electronic device with the coordinate origin as a starting point to traverse the entire to-be-localized area, calculating and recording coordinate values of a position of one of obstacles each time when it is detected by the mobile electronic device based on a moving direction and a moving distance of the mobile electronic device relative to the starting point during the traversing process;

constructing a map based on recorded information of spot mark and corresponding coordinate values and the coordinate values of the position of each said obstacle after the traversing process is finished.

According to another embodiment of the present invention, the number of light-emitting devices is two or more, and each said light-emitting device is respectively disposed at a specific position in the upper part of the to-be-localized area, and the information of the spot mark directly emitted by each said light-emitting device includes unique encoding information for distinguishing its absolute position; the method further comprises step of:

calculating coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, recording information of the spot mark of the other light-emitting device and corresponding coordinate values.

According to another embodiment of the present invention, the unique encoding information is represented by any one of the following ways or combinations:

number of emitting lights of a light-emitting device;

specific shape formed by emitting lights of a light-emitting device;

number of times for turning on and off a light emitting device within a certain period of time;

time for turning on and off a light emitting device within a certain period of time; or

combination of emitting lights with different colors of a light emitting device.

According to another embodiment of the present invention, the information of the spot mark directly emitted by each said light-emitting devices further includes area coding information for distinguishing accessible area/unaccessible area, and specific area behind a boundary where the light-emitting device directly emitting the area coding information of the unaccessible area is located is limited as unaccessible area, the area coding information represents the accessible area by the same type of information and represents the unaccessible area by another type of information; the method further comprises step of:

identifying whether the area coding information in the information of the spot mark represents accessible area or unaccessible area once the mobile electronic device obtains any information of the spot mark emitted by one of light-emitting devices, and moving the mobile electronic device to avoid the unaccessible area according to a preset avoiding strategy if the unaccessible area is identified.

According to another embodiment of the present invention, the method further comprises step of:

making marks of the accessible area/unaccessible area on the constructed map according to the area coding information of the spot mark during map-constructing process based on the recorded information of the spot mark and the corresponding coordinate values and the coordinate values of the position of each said obstacle after the traversing process is finished.

According to another embodiment of the present invention, the information of the spot mark emitted by any one of light-emitting devices further comprises area coding information used for limiting moving range; the method further comprises:

controlling the mobile electronic device to move within the moving range when the mobile electronic device obtains the area coding information used for limiting moving range.

According to another embodiment of the present invention, the method further comprises:

calibration process: recording a first pixel position A1 and a second pixel position A2 on the CCD/CMOS respectively related to the centers of the spot marks directly emitted by any two of the light emitting devices, when the mobile electronic device is moved to a first position R1 of the map, thus obtaining distance of each pixel according to a map coordinate system as (A2−A1)/L, wherein (A2−A1) represents number of pixels between A2 and A1, and L represents distance between the two light emitting devices according to the map coordinate system; recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2; and

correcting process: moving the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two of light emitting devices, so as to obtain deviation distance of the mobile electronic device according to the map coordinate system as L_{deviation}=(A3)(A3−A1)*(A2−A1)/L; and recording angle α2 between the pixel position A3 and the fourth pixel position A4, so as to obtain deviation angle α_{deviation}=α2−α1; correcting coordinate values of the constructed map based on the deviation distance L_{deviation} and the deviation angle α_{deviation}.

According to another embodiment of the present invention, the angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

x2 and y2 are respectively pixel differences of a line segment formed by the third pixel position A3 and the forth pixel position A4 on the X-axis and the Y-axis of the CCD/CMOS.

According to another embodiment of the present invention, the mobile electronic device is a robot.

According to another embodiment of the present invention, the method is applicable for real-time map constructing of indoor to-be-localized area; or/and the light-emitting device is suitable to be mounted on wall, ceiling or doorframe.

The present invention provides a method for map correcting based on light-emitting device, wherein the method comprises:

calibration step: recording a first pixel position A1 and a second pixel position A2 on the CCD/CMOS respectively related to centers of spot marks directly emitted by any two of light emitting devices, when a mobile electronic device is moved to a first position R1 of a map, thus obtaining distance of each pixel according to a map coordinate system as (A2−A1)/L, wherein (A2−A1) represents number of pixels between A2 and A1, and L represents distance between the two light emitting devices according to the map coordinate system; recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2; and

correcting step: moving the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two of light emitting devices, so as to obtain deviation distance of the mobile electronic device according to the map coordinate system as L_{deviation}=(A3−A1)*(A2−A1)/L; and recording angle α2 between the pixel position A3 and the fourth pixel position A4, so as to obtain deviation angle α_{deviation}=α2−α1; correcting coordinate values of the constructed map based on the deviation distance L_{deviation} and the deviation angle α_{deviation}.

The present invention provides another method for map correcting based on light-emitting device, wherein the method comprises:

moving a mobile electronic device to a reference coordinate point obtained in initial calibration process, recording a third pixel position A3 and a forth pixel position A4 on CCD/CMOS respectively related to centers of spot marks directly emitted by any two of light emitting devices; calculating deviation distance of the mobile electronic device according to a map coordinate system as L_{deviation}=(A3−A1)*L′, based on distance of each pixel L′ in the map coordinate system obtained in the initial calibration process and pixel differences between the third pixel position A3 and a first pixel position A1 correspondingly obtained in the initial calibration process;

recording angle α2 between the third pixel position A3 and the fourth pixel position A4, and obtaining deviation angle α_{deviation}=α2−α1 based on angle α1 between the pixel position A1 and a second pixel position A2; and

correcting coordinate values on constructed map based on the deviation distance L_{deviation} and the deviation angle α_{deviation}.

The present invention provides an apparatus for map constructing based on light-emitting device, wherein the apparatus is applicable for real-time mapping of a to-be-localized area, upper part of the to-be-localized area is provided with light-emitting device, the apparatus is a mobile electronic device and the apparatus comprises:

a camera, configured to collect spot mark directly emitted by light-emitting device;

a coordinate system constructing and recording unit, configured to take a position of a mobile electronic which is moving along a certain trajectory as a coordinate origin of a map coordinate system, when a center of a spot mark emitted by a first light-emitting device and collected by the camera of the mobile electronic device coincides with central point of CCD/CMOS, and record information of the spot mark of the first light-emitting device and corresponding coordinate values;

an encoder, configured to record a moving distance and a moving direction of the mobile electronic device relative to a starting point in real time through gyroscope when the mobile electronic device traverses the entire to-be-localized area with the coordinate origin as the starting point;

an obstacle detecting unit, configured to detect obstacles;

a first calculating unit, configured to calculate coordinate values of the location of each said obstacle based on the moving direction and the moving distance of the mobile electronic device relative to the starting point recorded by the encoder when the mobile electronic device detects any one of the obstacle, and send the calculated coordinate values to the coordinate system constructing and recording unit; and

a map constructing unit, configured to construct a map according to information of the spot mark and corresponding coordinate values and the coordinate values of the location of each said obstacle recorded by the coordinate system constructing and recording unit.

The present invention provides an apparatus for map correcting based on light-emitting device, wherein the apparatus comprises:

a calibration unit, configured to record a first pixel position A1 and a second pixel position A2 on CCD/CMOS respectively related to centers of spot marks directly emitted by any two of light emitting devices, when a mobile electronic device is moved to a first position R1 of a map, thus obtaining distance of each pixel according to a map coordinate system as (A2−A1)/L, wherein (A2−A1) represents number of pixels between A2 and A1, and L represents distance between the two light emitting devices according to the map coordinate system; record coordinate values of the first position R1 of the mobile electronic device according to the map coordinate system and coordinate values of the two pixel positions on the CCD/CMOS respectively related to the centers of the spot marks directly emitted by the two of light emitting devices, and record angle α1 between the pixel position A1 and the second pixel position A2; and

a correcting unit, configured to move the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two light emitting devices, so as to obtain deviation distance of the mobile electronic device according to the map coordinate system as L_{deviation} (A3−A1)*(A2−A1)/L; and record angle α2 between the pixel position A3 and the fourth pixel position A4, so as to obtain deviation angle α_{deviation}=α2−α1; correct coordinate values of the constructed map based on the deviation distance L_{deviation} and the deviation angle α_{deviation}.

The present invention provides an apparatus for map constructing based on light-emitting device, wherein the apparatus comprises:

a deviation distance calculating unit, configured to move a mobile electronic device to a reference coordinate point obtained in initial calibration process, recording a third pixel position A3 and a forth pixel position A4 on CCD/CMOS respectively related to centers of spot marks directly emitted by any two of light emitting devices; calculate deviation distance of the mobile electronic device according to a map coordinate system as L_{deviation}=(A3−A1)*L′, based on distance of each pixel in the map coordinate system obtained by the initial calibration process and pixel differences between the third pixel position A3 and a first pixel position A1 obtained in the initial calibration process;

a deviation angle calculating unit, configured to record angle α2 between the third pixel position A3 and the fourth pixel position A4, and obtaining deviation angle α_{deviation}=α2−α1 based on angle α1 between the pixel position A1 and a second pixel position A2; and

a correcting unit, configured to correct coordinate values on constructed map based on the deviation distance L_{deviation} and the deviation angle α_{deviation}.

Compared with the prior art, the method and apparatus for map constructing and map correcting based on light-emitting device disclosed by the present invention is achieved by arranging at least one light-emitting device in a to-be-localized area, taking a position of a mobile electronic as a coordinate origin of a map coordinate system when a center of a spot mark emitted by a first light-emitting device and detected by a camera of a mobile electronic device coincides with central point of CCD/CMOS, and recording information of the spot mark of the first light-emitting device and corresponding coordinate values; and moving the mobile electronic device with the coordinate origin as a starting point to traverse the entire to-be-localized area, calculating and recording coordinate values of a position of one of obstacles each time when it is detected by the mobile electronic device based on a moving direction and a moving distance of the mobile electronic device relative to the starting point during the traversing process; and constructing a map based on recorded information of the spot mark and corresponding coordinate values and the coordinate values of the position of each said obstacle after the traversing process is finished. As a result, only a light-emitting device or more (e.g. LED source, laser source or infrared source) is needed to realize localization and mapping for the to-be-localized area according the present invention, and the method is simple, of high accuracy and has the advantages of low cost, being simple to operate and high efficiency. In addition, after the map constructing is completed, the camera can be used to correct the constructed map by recognizing the light emitting device, so as to prevent map errors caused by gyroscope drifting or wheel slipping of the mobile electronic device.

### BRIEF DESCRIPTION OF THE DRAWINGS

FIG. 1 is a flowchart of a method for map constructing based on light-emitting device according to embodiment 1 of the present invention.

FIG. 2 is a flowchart of a method for map constructing based on light-emitting device according to embodiment 2 of the present invention.

FIG. 3 is a flowchart of a method for map constructing based on light-emitting device according to embodiment 3 of the present invention.

FIG. 4 is a flowchart of a method for map constructing based on light-emitting device according to embodiment 4 of the present invention.

FIG. 5 is composition block diagram of an apparatus for map constructing based on light-emitting device according to embodiment 5 of the present invention.

FIG. 6 is composition block diagram of an apparatus for map constructing based on light-emitting device according to embodiment 6 of the present invention.

FIG. 7 is composition block diagram of an apparatus for map constructing based on light-emitting device according to embodiment 7 of the present invention.

FIG. 8 is composition block diagram of an apparatus for map constructing based on light-emitting device according to embodiment 8 of the present invention.

FIG. 9 is a flowchart of a method for map correcting based on light-emitting device according to embodiment 9 of the present invention.

FIG. 10 is a flowchart of a method for map correcting based on light-emitting device according to embodiment 10 of the present invention.

FIG. 11 is composition block diagram of an apparatus for map correcting based on light-emitting device according to embodiment 11 of the present invention.

FIG. 12 is composition block diagram of an apparatus for map correcting based on light-emitting device according to embodiment 12 of the present invention.

FIG. 13 shows correcting process for the constructed map.

FIG. 14 shows correcting principle for distance and angle in the way that two more light-emitting devices simultaneously emit spot marks on the CCD/CMOS.

### DETAILED DESCRIPTION OF ILLUSTRATED EMBODIMENTS

The technical solutions of the embodiments according to the present invention are clearly and fully described as below with reference to the accompanying drawings in the embodiments of the present invention. Apparently, the embodiments to be described are merely a part rather than all of the embodiments of the present invention. All other embodiments obtained by persons with ordinary skills in the art based on the embodiments of the present invention without creative efforts shall fall within the protection scope of the present invention.

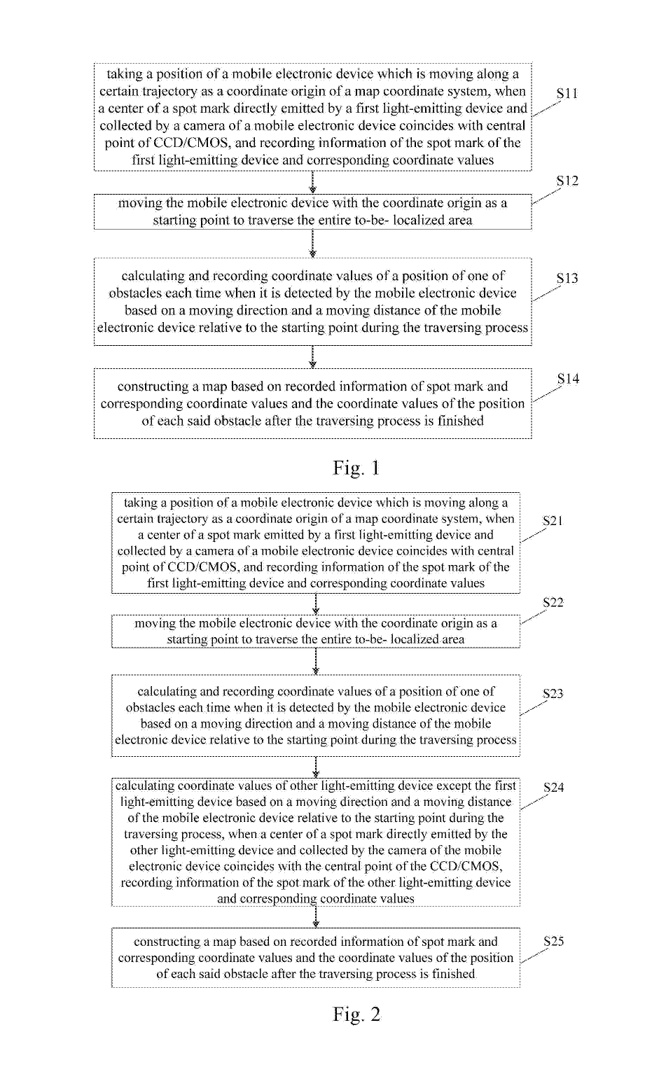

Referring to FIG. 1, it is a flowchart of a method for map constructing based on light-emitting device according to embodiment 1 of the present invention. The method for map constructing based on light-emitting device is applicable for real-time mapping of a to-be-localized area provided with at least one light-emitting device through a mobile electronic device. The mobile electronic device can be, for example, a robot.

The method for map constructing based on light-emitting device comprises steps of:

Step 11, taking a position of a mobile electronic device which is moving along a certain trajectory as a coordinate origin of a map coordinate system, when a center of a spot mark directly emitted by a first light-emitting device and collected by a camera of a mobile electronic device coincides with central point of CCD/CMOS, and recording information of the spot mark of the first light-emitting device and corresponding coordinate values;

Step 12, moving the mobile electronic device with the coordinate origin as a starting point to traverse the entire to-be-localized area;

Step 13, calculating and recording coordinate values of a position of one of obstacles each time when it is detected by the mobile electronic device based on a moving direction and a moving distance of the mobile electronic device relative to the starting point during the traversing process; and

Step 14, constructing a map based on recorded information of spot mark and corresponding coordinate values and the coordinate values of the position of each said obstacle after the traversing process is finished.

In step 11, after arranging light-emitting device (e.g., LED source, laser source and infrared source) in at least one specific position/any position of the to-be-localized, it is necessary to have the mobile electronic traversing the entire area to obtain relevant information in the area, thus realizing localization and mapping for the entire area. At the beginning of the first traversal, when a center of a spot mark emitted by a first light-emitting device and collected by a camera of a mobile electronic device coincides with central point of CCD/CMOS, a position of the first light-emitting device (that is, a current position of the mobile electronic device) is taken as the coordinate origin of a map coordinate system composed of X-axis and Y-axis, and information of the spot mark of the first light-emitting device and corresponding coordinate values are recorded. As can be understood, corresponding coordinate values herein is referred to coordinate values of the position of the first light-emitting device, that is, the coordinate values of the current position of the mobile electronic device.

As can be understood, in order to facilitate calculation and composition, a position of the mobile electronic device is taken as the coordinate origin of a map coordinate system composed of X-axis and Y-axis when the center of the spot mark emitted by the first light-emitting device and detected by the camera of the mobile electronic device coincides with the central point of the CCD/CMOS. However, the position of the mobile electronic device is not limited as the coordinate origin of the coordinate system composed of the X-axis and the Y-axis, and may be marked as other reference points, so as to have a reference function to facilitate recording information of other points.

According to the present embodiment, at least one light-emitting device is correspondingly arranged at a specific position of the to-be-localized area, and the information of the spot mark emitted by the light-emitting device comprises unique coding information used for distinguishing an absolute position thereof, the unique coding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device.

As can be understood, composition of the information of the spot mark is in a variety of ways. Specifically, it is more convenient to select a way for composition of the information of the spot mark by considering the number of marks needed in the environment of to-be-localized area. In this embodiment, the mobile electronic device reads the information of the spot mark through a camera.

In steps 12˜13, the mobile electronic device is moved to traverse the entire to-be-localized area with the coordinate origin as a starting point when it is determined that the position where the mobile electronic device detects the first light-emitting device is taken as the coordinate origin. Furthermore, when the mobile electronic device starts to move from the starting point, calculation of a moving direction and a moving distance of the mobile electronic device relative to the starting point is started up in real time (for example, the moving path and relative position and angle of the robot can be recorded in real time through encoder installed on driving wheel axle of the robot, so that the position (including the distance and the direction) of the mobile electronic device relative to the starting point can be obtained through calculation). When the mobile electronic device detects an obstacle each time during the traversing process, the coordinate values of the position of the obstacle can be calculated in the following approaches:

Approach 1: The obstacle is sensed by using a collision sensor, and current coordinate values of the mobile electronic device are taken as the coordinate values of the position of the obstacle when the collision sensor senses a collision with the obstacle.

Approach 2: the obstacle is detected by using a laser sensor/a infrared sensor, and the position of the obstacle relative to the current location of the mobile electronic device is calculated on the basis of a laser/infrared distance calculating principle when the laser sensor/infrared sensor detects the obstacle, thus the coordinate values of the position of the obstacle are calculated.

Moreover, an additional collision strategy is set in the present embodiment. That is, when the mobile electronic device has collided with an obstacle during the traversing process, the mobile electronic device is moved to avoid the obstacle according to a preset collision strategy.

According to a preferable embodiment of the present invention, the preset collision strategy comprises: when the mobile electronic device senses a collision with the obstacle through (for example, a collision sensor), the mobile electronic device will perform an intelligent analysis to determine the ways of further movement. For example, the mobile electronic device may choose to retreat by greater than 0 cm and less than 20 cm and rotate to the right or left by 1-10 degrees according to a specific environmental pattern of the to-be-localized area. When the mobile electronic device is in a confined space, the mobile electronic device may choose to retreat by greater than 0 and less than 2 cm. Furthermore, the mobile electronic device chooses a larger angle of rotation, for example, the rotation angle of 2 degrees or even 10 degrees, when collision points of consecutive rotations for 3 times by 1 degree are in a plane.

As can be understood, in addition to the preset collision strategy disclosed herein, the collision strategy according to the present embodiment can also adopt other approaches, which is not limited thereto.

Therefore, according the preset collision strategy, the mobile electronic device continue to move to detect the coordinate values of other mark and other obstacle, and the traversal for one time is accomplished until the entire to-be-localized area has been traversed. As can be understood, all the feature information (including the position of the spot mark and the position of each said obstacle) of the to-be-localized area is recorded after the mobile electronic device has accomplished the traversal for one time.

In step 14, a map is constructed on the basis of the recorded information of the spot mark and the corresponding coordinate values and the coordinate values of the position of each said obstacle after the mobile electronic device has accomplished the traversal for one time. The more recorded information, the richer and more detailed the constructed map will be. For example, when the mobile electronic device collides with an obstacle, the coordinate values of the obstacle are recorded, so that when the mobile electronic device which is arranged in the indoor environment has traversed the entire room, the coordinate values of all the obstacles can be recorded continuously, and the obstacles surrounds as periphery and at the same time makes a circle which can be considered as a wall, so that a barrier-free region area, an obstacle area and a wall area of the room can be separated and consequently the map of the whole room is constructed.

As can be understood, the constructed map is 2D map, and the mobile electronic device (for example, a robot) may navigate according to the constructed map.

It can be seen that only a light-emitting device or more (e.g. LED source, laser source or infrared source) is needed to realize localization and mapping for the to-be-localized area according to the present invention, and the method is simple, of high accuracy and has the advantages of low cost, being simple to operate and high efficiency.

Referring to FIG. 2, it is a flowchart of a method for map constructing based on light-emitting device according to embodiment 2 of the present invention. The method for map constructing based on light-emitting device is applicable for real-time mapping of a to-be-localized area provided with two or more light-emitting devices through a mobile electronic device. Each said light-emitting device is arranged at a specific position of the to-be-localized area, and the information of the spot mark directly emitted by each said light-emitting device includes unique encoding information for distinguishing its absolute position. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The mobile electronic device can be, for example, a robot.

The method for map constructing based on light-emitting device comprises steps of:

step 21, taking a position of a mobile electronic device which is moving along a certain trajectory as a coordinate origin of a map coordinate system, when a center of a spot mark emitted by a first light-emitting device and collected by a camera of a mobile electronic device coincides with central point of CCD/CMOS, and recording information of the spot mark of the first light-emitting device and corresponding coordinate values;

step 22, moving the mobile electronic device with the coordinate origin as a starting point to traverse the entire to-be-localized area;

step 23, calculating and recording coordinate values of a position of one of obstacles each time when it is detected by the mobile electronic device based on a moving direction and a moving distance of the mobile electronic device relative to the starting point during the traversing process;

step 24, calculating coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, recording information of the spot mark of the other light-emitting device and corresponding coordinate values; and

step 25, constructing a map based on recorded information of the spot mark and corresponding coordinate values and the coordinate values of the position of each said obstacle after the traversing process is finished.

As can be understood, steps 21˜23 and step 25 in the present embodiment are basically consistent with steps 11˜13 and 14 as shown in FIG. 1, which will not be repeated thereto.

Different from the embodiment 1, since the method of the present embodiment is applicable to localize the to-be-localized area arranged with two or more light-emitting devices, and each said light-emitting device is arranged at a specific position of the to-be-localized area, and information of the spot mark emitted by each light-emitting device comprises unique coding information used for distinguishing its absolute position. Therefore, during the mobile electronic device's traversing process, in addition to calculating and recording the coordinate values of the position of one of the obstacles each time when an obstacle is detected by the mobile electronic device, the coordinate values of other light-emitting device except the first light-emitting device are calculated by the mobile electronic device when the mobile electronic device obtains information of the spot mark of the other light-emitting device, that is, step 24.

Similarly, a current position of the mobile electronic device is taken as a corresponding position of other light-emitting device when a center of a spot mark emitted by the other light-emitting device and detected by a camera of a mobile electronic device coincides with central point of CCD/CMOS, and the coordinate values of the position and corresponding information of the spot mark are recorded.

As can be understood, the information of the spot mark of the light-emitting device obtained by the mobile electronic device herein mainly contains unique encoding information for distinguishing absolute position thereof. For example, when at least two light-emitting devices are placed at different specific positions (for example, room 1, room 2, . . . ) of the to-be-localized area, it is necessary to determine and distinguish the specific location (absolute location) where any one of the light-emitting devices is located by identifying the unique encoding information of the light-emitting device, for example, the light-emitting device is located in room 1 or room 2 or the like. Therefore, the absolute position where the light-emitting device is located can be identified and then determined by obtaining the unique encoding information of the light-emitting device.

The representations of the unique encoding information of the information of the spot mark can be referred to the related description of the t embodiment 1 as described above.

As can be understood, the method for map constructing based on light-emitting device according to the present embodiment is applicable for real-time mapping for indoor to-be-localized area. When localizing the indoor environment, it is preferable to place one light-emitting device on a wall, ceiling or left side wall, right side wall or upper wall of door frame in each room.

In this way, the mobile electronic device can realize navigating and identifying absolute position based on the unique encoding information of each said light-emitting device after the map construction is accomplished based on the recorded information of the spot mark of each said light-emitting device and the coordinate values thereof and the coordinate values of each said obstacle. For example, when the robot is required to traverse the room 2 for one time, the absolute position of the room 2 can be determined based on the unique encoding information of the information of the spot mark emitted by the light-emitting device mounted on the left, right side wall or upper wall of the door frame in the room 2 and the mobile electronic device is navigated to arrive in the room 2 based on the relative coordinate values (direction and distance relative to the coordinates origin) of the light-emitting device on the constructed map.

In addition, the mobile electronic device (the robot) knows where it is located based on the unique encoding information in the information of the spot mark of each said light-emitting device. For example, a cleaning robot, which is required to clean a plurality of rooms, can determine which room it is located in by identifying the unique coding information of the corresponding light-emitting device of each room, so as to avoid multiple cleanings for the same room and reduce repeated work. The main purpose of distinguishing the rooms is cleaning one room after one room, so the efficiency will be higher. In this way, the robot traversal will cover a lot less repetitive routes.

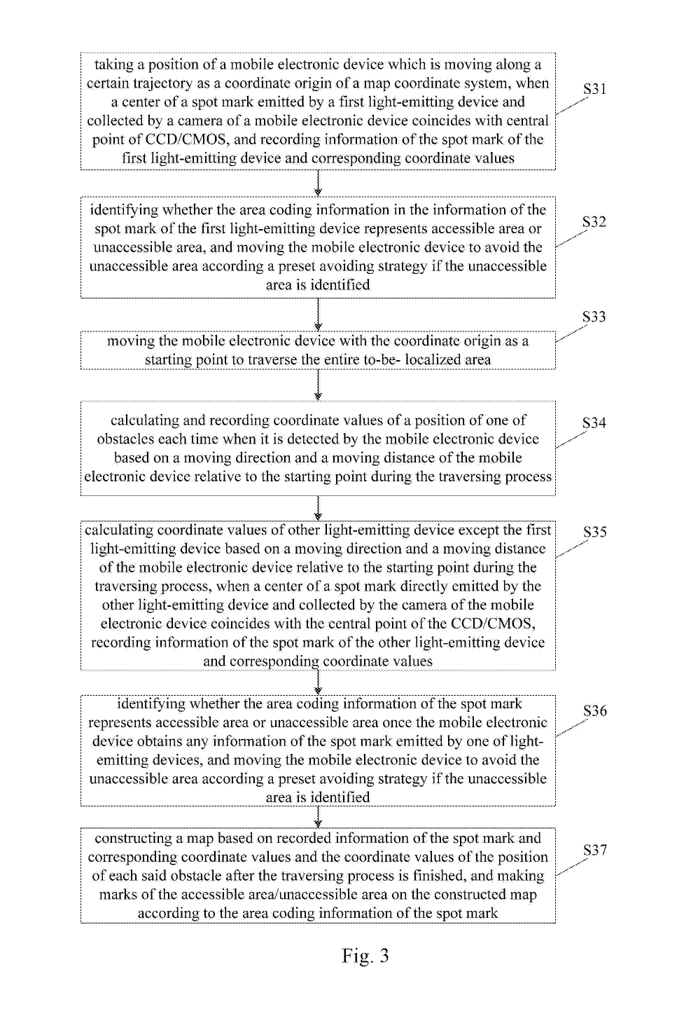

Referring to FIG. 3, it is a flowchart of a method for map constructing based on light-emitting device according to embodiment 3 of the present invention. The method for map constructing based on light-emitting device is applicable for real-time mapping of a to-be-localized area provided with two or more light-emitting devices by a mobile electronic device. Each said light-emitting device is arranged at a specific position of the to-be-localized area, and information of the spot mark directly emitted by each said light-emitting device includes unique encoding information for distinguishing its absolute position and area coding information for distinguishing accessible area/unaccessible area. Specific area behind a boundary where the light-emitting device directly emitting the area coding information of the unaccessible area is located is limited as unaccessible area. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The area coding information represents the accessible area by the same shape and represents the unaccessible area by another shape. The mobile electronic device can be, for example, a robot.

The method for map constructing based on light-emitting device comprises steps of:

step 31, taking a position of a mobile electronic device which is moving along a certain trajectory as a coordinate origin of a map coordinate system, when a center of a spot mark emitted by a first light-emitting device and collected by a camera of a mobile electronic device coincides with central point of CCD/CMOS, and recording information of the spot mark of the first light-emitting device and corresponding coordinate values;

step 32, identifying whether the area coding information in the information of the spot mark of the first light-emitting device represents accessible area or unaccessible area, and moving the mobile electronic device to avoid the unaccessible area according a preset avoiding strategy if the unaccessible area is identified;

step 33, moving the mobile electronic device with the coordinate origin as a starting point to traverse the entire to-be-localized area;

step 34, calculating and recording coordinate values of a position of one of obstacles each time when it is detected by the mobile electronic device based on a moving direction and a moving distance of the mobile electronic device relative to the starting point during the traversing process;

step 35, calculating coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, recording information of the spot mark of the other light-emitting device and corresponding coordinate values;

step 36, identifying whether the area coding information of the spot mark represents accessible area or unaccessible area once the mobile electronic device obtains any information of the spot mark emitted by one of light-emitting devices, and moving the mobile electronic device to avoid the unaccessible area according a preset avoiding strategy if the unaccessible area is identified; and

step 37, constructing a map based on recorded information of the spot mark and corresponding coordinate values and the coordinate values of the position of each said obstacle after the traversing process is finished, and making marks of the accessible area/unaccessible area on the constructed map according to the area coding information of the spot mark.

Information of the spot marks of all the light-emitting devices comprises the unique encoding information and the area coding information. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The area coding information represents the accessible area by the same type of information and represents the unaccessible area by another type of information.

In addition, as an improvement of the present embodiment, the information of the spot mark emitted by any one of light-emitting devices further comprises area coding information used for limiting moving range.

The mobile electronic device is controlled to move within the moving range when the mobile electronic device obtains the area coding information used for limiting moving range.

It can be seen that the present embodiment adds a function on the basis of the embodiment 2. That is, solving the problem of the automatic identification of the unaccessible area (also referred to virtual wall). The conventional method to solve the problem of the robot identification of the unaccessible area mainly adopts the following approaches:

One approach is that an infrared emitting device is set on a boundary of the expected unaccessible area and robot will not cross the boundary if detecting the infrared rays, which is proposed by irobot Company. The disadvantage of the approach is that the infrared emission device needs to be installed with a battery, so as to cause some inconvenience for users, on the other hand, the device is placed near the boundary, so that the device may move and thus fail to function if the device is touched by domestic pets or the like.

Another approach is using magnetic stripe as the boundary proposed by Neato Company, which requires users to attach the magnetic stripe to the boundary of the unaccessible area, which is identified by using Hall sensors. The disadvantage of the approach lies in that the magnetic stripe attached to ground affects the ground appearance. On the other hand, if users want to replace the unaccessible area, it is inconvenient to take off the magnetic stripe.

The area coding information used for distinguishing the accessible area/unaccessible area is arranged in the mark directly emitted by each light-emitting device according to the present embodiment, wherein the light-emitting device with the area coding information for unaccessible area limits the specific area behind the boundary where the light-emitting device is located as unaccessible area. In this way, when the mobile electronic device identifies the area coding information of the mark, the accessible area/unaccessible area can be distinguished. The mobile electronic device continues to move to avoid the unaccessible area according to the preset avoiding strategy if the unaccessible area is identified. In addition, when the traversal has been finished, marks of the accessible area/unaccessible area are made on the constructed map on basis of the area coding information of the mark of each light-emitting device for the benefit of navigation.

As can be understood, a relation comparison table for area coding information of the different marks representing the accessible area/unaccessible area can be set in advance in the mobile electronic device, so that when the area coding information of each said spot mark is acquired, the accessible area or unaccessible area can be identified according the comparison table.

The preset avoiding strategy in the present embodiment is preferably as: making the mobile electronic device retreat by P cm and rotate to the left/right by Q when the unaccessible area is identified, wherein P is not less than the length of the boundary, 45≤Q≤90. Based on the preset avoiding strategy, it basically guarantees that the mobile electronic device can continue to advance to avoid the obstacle.

Furthermore, the boundary between the accessible area and unaccessible area can be identified in the following manners: when the mobile electronic device judges that the area coding information of the spot mark represents the unaccessible area, the mobile electronic device is moved to find obstacles (the wall) and barrier-free area on the left and right sides of the light-emitting device, and the extension line of the wall is the boundary between the accessible area and unaccessible area.

As can be understood, in addition to the avoiding strategy disclosed herein, the avoiding strategy of the present embodiment can also adopt other approaches, which is not limited thereto.

When performing the method for indoor localization and mapping according to the present embodiment, it is preferable to place one light-emitting device on a wall, ceiling or left side wall, right side wall or upper wall of door frame in each room.

It can be seen that compared with the virtual wall technique according to the prior art, the area coding information used for distinguishing the accessible area and unaccessible area is set in the spot mark of each light-emitting device according to the embodiment of the present invention, so that the mobile electronic device may determine the area is accessible after obtaining and identifying the area coding information of the spot mark. Therefore, the cost is low, and appearance as a whole will not be affected, and it is easy to replace light-emitting device according to the present embodiment.

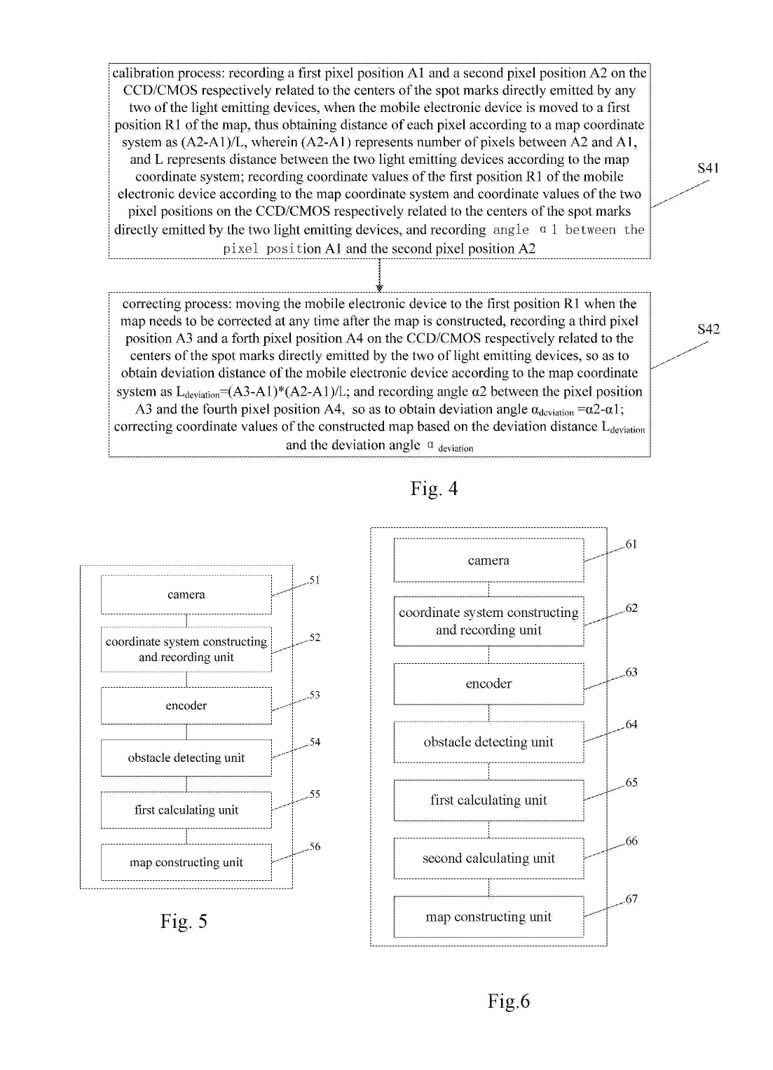

Referring to FIG. 4, it is a flowchart of a method for map constructing based on light-emitting device according to embodiment 4 of the present invention. When moving direction and moving distance of a robot relative to a starting point are measured in real time by encoder installed on drive axle of the robot, accumulation errors exist in the measurement process of the encoder due to slipping, ambiguous distance between one of the two drive wheels and the ground contact point and the like. In addition, gyroscope drifting can also cause deviations in constructed map. Therefore, on the basis of the foregoing embodiment, the constructed map is corrected to prevent map errors caused by gyroscope drifting or wheel slipping of the mobile electronic device according to the present embodiment, so that the map constructed based on coordinate values is further improved to be more accurate.

Specifically, after constructing a map by performing the foregoing embodiment 1 to embodiment 3, a correction processing is added to a map according to the present embodiment, which specifically comprises:

step 41, calibration process: recording a first pixel position A1 and a second pixel position A2 on the CCD/CMOS respectively related to the centers of the spot marks directly emitted by any two of the light emitting devices, when the mobile electronic device is moved to a first position R1 of the map, thus obtaining distance of each pixel according to a map coordinate system as (A2−A1)/L, wherein (A2−A1) represents number of pixels between A2 and A1, and L represents distance between the two light emitting devices according to the map coordinate system; recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2; and

step 42, correcting process: moving the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two of light emitting devices, so as to obtain deviation distance of the mobile electronic device according to the map coordinate system as L_{deviation}=(A3−A1)*(A2−A1)/L; and recording angle α2 between the pixel position A3 and the fourth pixel position A4, so as to obtain deviation angle α_{deviation}=α2−α1; correcting coordinate values of the constructed map based on the deviation distance L_{deviation} and the deviation angle α_{deviation}.

The angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

x2 and y2 are respectively pixel differences of a line segment formed by the third pixel position A3 and the forth pixel position A4 on the X-axis and the Y-axis of the CCD/CMOS.

According to the present embodiment, two coordinate systems are set in the mobile electronic device; one is a map construction coordinate system of the to-be-localized area, and the other is a CCD/CMOS coordinate system of the camera in the mobile electronic device. The CCD/CMOS coordinate system refers to pixel position of the CCD/CMOS onto which a spot mark is emitted by light-emitting device, and the CCD/CMOS coordinate system also includes an X axis and a Y axis.

Prior to correcting the constructed map according to the present embodiment, it needs to perform calibration process firstly. For example, for indoor localizing and mapping, the height of each house is different, so that when the spot mark of light-emitting device is deviated by one pixel on the X axis or the Y axis of the CCD/CMOS of the camera, distance of movement of the mobile electronic device in the map coordinate system (i.e., the ground coordinate system) changes, thereby it needs to perform calibration process firstly.

The detailed calibration process is that when the mobile electronic device (for example, a robot) reaches the first position R1 during moving process, the camera detects centers of two spot marks directly emitted from the two light emitting devices and projected on the CCD/CMOS, as shown as the first pixel position A1 and the first pixel position A2 in the FIG. 13. Thus, number of pixels between the first pixel position A1 and the first pixel position A2 can be calculated. By the means that the distance between the two light emitting devices in the map coordinate system is divided by the pixel numbers, distance of the robot corresponding to one pixel can be calculated in the ground coordinate system. At the same time, coordinate values of the mobile electronic device at the first position R1 in the map coordinate system are recorded, and coordinate values of the centers of the spot marks directly emitted by the two light emitting devices onto the CCD/CMOS are recorded, as well as the angle α1 between the pixel position A1 and the second pixel position A2 (for example, relative to the horizontal plane).

After the calibration process is completed, when the robot which runs for a period of time (for example, 20 minutes) needs to correct the constructed map, the robot moves to the position where the reference coordinate point is (i.e., the first position R1). By this time, according to differences between any one of the two pixel positions of the CCD/CMOS and the corresponding position previously, it can be known that how many pixels are deviated. By the means that the deviated pixels are multiplied by the distance obtained in the calibration process, it can be determined that how far the robot deviates in the ground coordinate system.

For example, with the first pixel position A1 as a reference point, when the mobile electronic device is moved to the first position R1, the centers of the spot marks directly emitted by the two light emitting devices are directly projected onto the CCD/CMOS, as shown as the third pixel position A3 and the fourth pixel position A4 in FIG. 13, so as to obtain deviation distance of the mobile electronic device according to the map coordinate system as L_{deviation}=(A3−A1)*(A2−A1)/L. Angle α2 between the pixel position A3 and the fourth pixel position A4 is recorded, so as to obtain deviation angle as α_{deviation}=α2−α1.

By this time, coordinate values on the constructed map are corrected based on the deviation distance L_{deviation} and the deviation angle α_{deviation}, so as to obtain the corrected map.

It can be understood that this embodiment corrects the deviation of distance and angle based on the centers of the spot marks on the CCD/CMOS simultaneously emitted by two light emitting devices. For example, when the light emitting devices are red LEDs, there exits two distinct bright spots on the CCD, and the bright spots may occupy tens or hundreds of pixels on the CCD. According to the present embodiment, center of the tens or hundreds of pixels serves as the center of the bright spot.

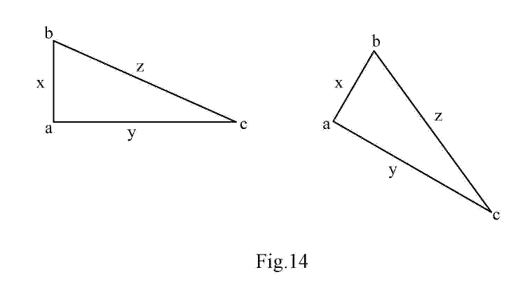

In addition, in this embodiment, the correction of distance deviation and angle deviation can also be performed by using more than two light emitting devices to simultaneously emit spot marks onto the CCD/CMOS. Referring to FIG. 14, it is assumed that the corresponding relationship between the vertices (a, b, and c) of the respective sides (x, y, and z) is known in advance (the vertex is the center point of the bright spot). If the centers of three bright spots form a triangle, to correct the coordinates or angles, it is necessary to know that as long as the lengths of the three sides are not the same, the corresponding relationship of bright spots can be determined in the next correction process. Any one of vertices a, b, and c can be used to correct the coordinates, and all the three line segments x, y, and z can be used to correct the angle.

Referring to FIG. 5, it is composition block diagram of an apparatus for map constructing based on light-emitting device according to embodiment 5 of the present invention. The apparatus for map constructing is a mobile electronic device or arranged in a mobile electronic device, which is applicable for real-time mapping of a to-be-localized area provided with at least one light-emitting device. The mobile electronic device can be, for example, a robot.

The apparatus for map constructing comprises:

a camera 51, configured to collect spot mark directly emitted by light-emitting device;

a coordinate system constructing and recording unit 52, configured to take a position of a mobile electronic which is moving along a certain trajectory as a coordinate origin of a map coordinate system, when a center of a spot mark emitted by a first light-emitting device and collected by the camera 51 of the mobile electronic device coincides with central point of CCD/CMOS, and record information of the spot mark of the first light-emitting device and corresponding coordinate values;

an encoder 53, configured to record a moving distance and a moving direction of the mobile electronic device relative to a starting point in real time through gyroscope when the mobile electronic device traverses the entire to-be-localized area with the coordinate origin as the starting point;

an obstacle detecting unit 54, configured to detect obstacles;

a first calculating unit 55, configured to calculate coordinate values of the location of each said obstacle based on the moving direction and the moving distance of the mobile electronic device relative to the starting point recorded by the encoder when the mobile electronic device detects any one of the obstacle, and send the calculated coordinate values to the coordinate system constructing and recording unit 52; and

a map constructing unit 56, configured to construct a map according to information of spot mark and corresponding coordinate values and the coordinate values of the location of each said obstacle recorded by the coordinate system constructing and recording unit 52.

The operation principle and working process of the apparatus for map constructing according to the present embodiment can be referred to the embodiment 1, which will not be repeated thereto.

The obstacle detecting unit 54 comprises a collision sensor/a laser sensor/an infrared sensor:

The obstacle is sensed by using a collision sensor, and current coordinate values of the mobile electronic device are taken as coordinate values of a position of an obstacle when the collision sensor senses a collision with the obstacle;

The collision sensor component is used to sense a collision event of the mobile electronic device with external environment. The collision sensor component includes, but is not limited to, eccentric hammer sensors, ball-type crash sensors, roller-type expansion sensors, mercury-switched crash sensors, piezoresistive effect type crash sensors, piezoelectric effect type impact sensors, microswitches and the like.

The obstacle is detected by using a laser sensor/infrared sensor, and the position of the obstacle relative to the current location of the mobile electronic device is calculated on the basis of a laser/infrared distance calculating principle when the laser sensor/infrared sensor detects the obstacle, thus the coordinate values of the position of the obstacle is calculated.

According to the present embodiment, preferably, the mobile electronic device further comprises: a collision strategy unit, configured to enable the mobile electronic device to continue to advance to avoid the obstacle according to a preset collision strategy, when the mobile electronic device has collided with an obstacle during the traversing process.

The operation principle and working process of the collision strategy unit can be referred to the embodiment 1.

According to another preferable embodiment of the present invention, referring to FIG. 6, the apparatus for map constructing is a mobile electronic device or arranged in a mobile electronic device, which is applicable for real-time mapping of a to-be-localized area provided with two or more light-emitting devices, Each said light-emitting device is arranged at a specific position of the to-be-localized area, and information of the spot mark directly emitted by each said light-emitting device includes unique encoding information for distinguishing its absolute position. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The mobile electronic device can be, for example, a robot.

The apparatus for map constructing comprises:

a camera 61, configured to collect spot mark directly emitted by light-emitting device;

a coordinate system constructing and recording unit 62, configured to take a position of a mobile electronic which is moving along a certain trajectory as a coordinate origin of a map coordinate system, when a center of a spot mark emitted by a first light-emitting device and collected by the camera 61 of the mobile electronic device coincides with central point of CCD/CMOS, and record information of the spot mark of the first light-emitting device and corresponding coordinate values;

an encoder 63, configured to record a moving distance and a moving direction of the mobile electronic device relative to a starting point in real time through gyroscope when the mobile electronic device traverses the entire to-be-localized area with the coordinate origin as the starting point;

an obstacle detecting unit 64, configured to detect obstacles;

a first calculating unit 65, configured to calculate coordinate values of the location of each said obstacle based on the moving direction and the moving distance of the mobile electronic device relative to the starting point recorded by the encoder when the mobile electronic device detects any one of the obstacle, and send the calculated coordinate values to the coordinate system constructing and recording unit 62;

a second calculating unit 66, configured to coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, and send information of the spot mark of the other light-emitting device and corresponding coordinate values to the coordinate system constructing and recording unit 62; and

a map constructing unit 67, configured to construct a map according to the information of the spot marks and corresponding coordinate values and the coordinate values of the location of each said obstacle recorded by the coordinate system constructing and recording unit 62.

The operation principle and working process of the apparatus for map constructing according to the present embodiment can be referred to the embodiment 2, which will not be repeated thereto.

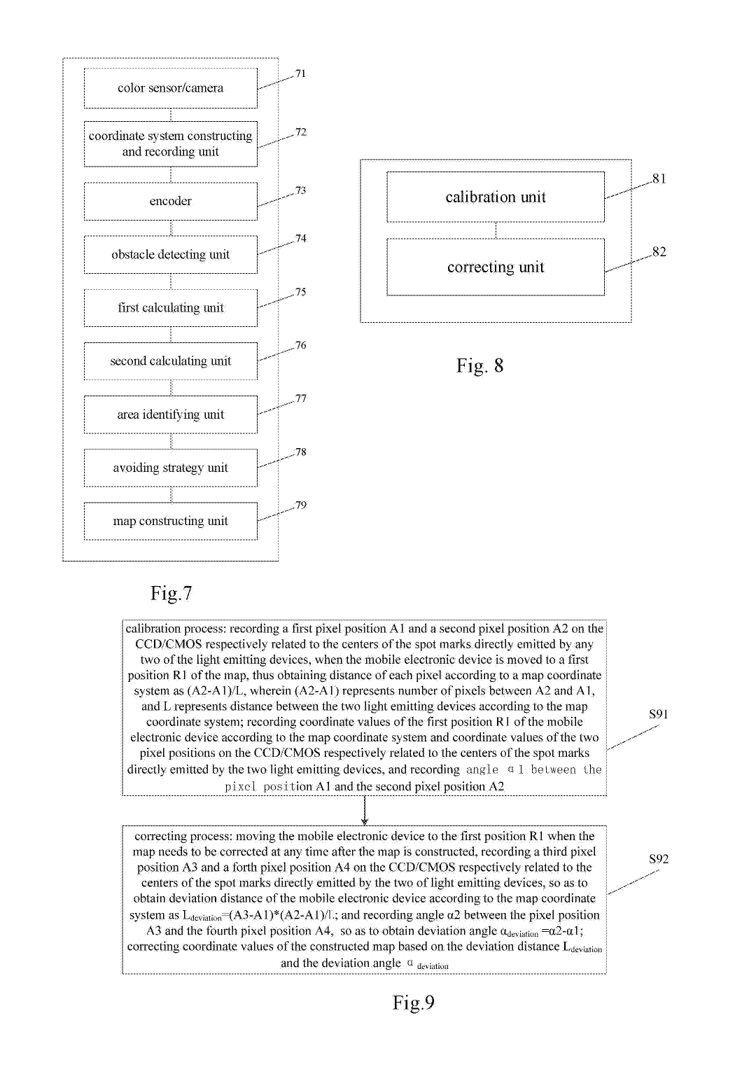

Referring to FIG. 7, it is composition block diagram of an apparatus for map constructing based on light-emitting device according to embodiment 7 of the present invention. The apparatus for map constructing is a mobile electronic device or arranged in a mobile electronic device, which is applicable for real-time mapping of a to-be-localized area provided with two or more light-emitting devices. Each said light-emitting device is arranged at a specific position of the to-be-localized area, and the information of the spot mark directly emitted by each said light-emitting device includes unique encoding information for distinguishing its absolute position and area coding information for distinguishing accessible area/unaccessible area. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The area coding information represents the accessible area by the same shape and represents the unaccessible area by another shape. The mobile electronic device can be, for example, a robot.

The apparatus for map constructing comprises:

a camera 71, configured to collect spot mark directly emitted by light-emitting device;

a coordinate system constructing and recording unit 72, configured to take a position of a mobile electronic which is moving along a certain trajectory as a coordinate origin of a map coordinate system, when a center of a spot mark emitted by a first light-emitting device and collected by the camera 71 of the mobile electronic device coincides with central point of CCD/CMOS, and record information of the spot mark of the first light-emitting device and corresponding coordinate values;

an encoder 73, configured to record a moving distance and a moving direction of the mobile electronic device relative to a starting point in real time through gyroscope when the mobile electronic device traverses the entire to-be-localized area with the coordinate origin as the starting point;

an obstacle detecting unit 74, configured to detect obstacles;

a first calculating unit 75, configured to calculate coordinate values of the location of each said obstacle based on the moving direction and the moving distance of the mobile electronic device relative to the starting point recorded by the encoder when the mobile electronic device detects any one of the obstacle, and send the calculated coordinate values to the coordinate system constructing and recording unit 72;

a second calculating unit 76, configured to record coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, and send information of the spot mark of the other light-emitting device and corresponding coordinate values to the coordinate system constructing and recording unit 72;

an area identifying unit 77, configured to identify whether the area coding information in the information of the spot mark represents accessible area or unaccessible area once the mobile electronic device obtains information of any spot mark emitted by one of light-emitting devices;

As can be understood, a relation comparison table for different area coding information of the light-emitting device representing the accessible area/unaccessible area can be set in advance in the mobile electronic device, so that when the area coding information of the spot mark is acquired, the accessible area or unaccessible area can be identified according the comparison table;

an avoiding strategy unit 78, configured to move the mobile electronic device to avoid the unaccessible area according a preset avoiding strategy if the unaccessible area is identified by the area identifying unit 77; and

a map constructing unit 79, configured to construct a map according to the information of the spot marks and corresponding coordinate values and the coordinate values of the position of each said obstacle recorded by the coordinate system constructing and recording unit 72, and make marks of the accessible area/unaccessible area on the constructed map according to the area coding information of the spot marks.

Information of the spot mark of all the light-emitting devices comprises the unique encoding information and the area coding information. The unique encoding information is represented by any one of the following ways or combinations: number of emitting lights of a light-emitting device; specific shape formed by emitting lights of a light-emitting device; number of times for turning on and off a light emitting device within a certain period of time; time for turning on and off a light emitting device within a certain period of time; or combination of emitting lights with different colors of a light emitting device. The area coding information represents the accessible area by the same type of information and represents the unaccessible area by another type of information.

In addition, as an improvement of the present embodiment, the information of the spot mark emitted by any one of light-emitting devices further comprises area coding information used for limiting moving range. The mobile electronic device is controlled to move within the moving range when the mobile electronic device obtains the area coding information used for limiting moving range.

The apparatus for map constructing in the present embodiment effectively solves the problem of automatically identifying unaccessible area (also referred to a virtual wall) exiting in the prior art, of which the operation principle and working process can be referred to the embodiment 3.

Referring to FIG. 8, it is composition block diagram of an apparatus for map constructing based on light-emitting device according to embodiment 8 of the present invention. On the basis of any one of apparatuses in the embodiments 5˜7, the present apparatus further comprises:

calibration unit 81, configured to record a first pixel position A1 and a second pixel position A2 on the CCD/CMOS respectively related to centers of spot marks directly emitted by any two of light emitting devices, when the mobile electronic device is moved to a first position R1 of the map, thus obtaining distance of each pixel according to a map coordinate system as (A2−A1)/L, wherein (A2−A1) represents the number of pixels between A2 and A1, and L represents distance between the two light emitting devices according to the map coordinate system; record coordinate values of the first position R1 of the mobile electronic device according to the map coordinate system and coordinate values of the two pixel positions on the CCD/CMOS respectively related to the centers of the spot marks directly emitted by the two of light emitting devices, and record angle α1 between the pixel position A1 and the second pixel position A2; and

correcting unit 82, configured to move the mobile electronic device to the first position R1 when the map needs to be corrected at any time after the map is constructed, record a third pixel position A3 and a forth pixel position A4 on the CCD/CMOS respectively related to the centers of the spot marks directly emitted by the two light emitting devices, so as to obtain deviation distance of the mobile electronic device according to the map coordinate system as L_{deviation} (A3−A1)*(A2−A1)/L; and record angle α2 between the pixel position A3 and the fourth pixel position A4, so as to obtain deviation angle α_{deviation}=α2−α1; correct coordinate values on the constructed map based on the deviation distance L_{deviation} and the deviation angle α_{deviation}.

The angle α1 and the angle α2 are calculated by the following equations:

α1=arc tan(y1/x1);

α2=arc tan(y2/x2);

wherein x1 and y1 are respectively pixel difference of a line segment formed by the first pixel position A1 and the second pixel position A2 on X-axis and Y-axis of the CCD/CMOS; and

x2 and y2 are respectively pixel difference of a line segment formed by the third pixel position A3 and the forth pixel position A4 on the X-axis and the Y-axis of the CCD/CMOS.

The operation principle and working process of the apparatus for map constructing according to the present embodiment can be referred to the embodiment 4, which will not be repeated thereto.

The present invention further discloses a smart mobile electronic device, which comprises a mobile electronic device and an apparatus for map constructing of any embodiment as shown in FIG. 5-FIG. 8.

Referring to FIG. 9, it is a flowchart of a method for map correcting based on light-emitting device according to embodiment 9 of the present invention. The method comprises:

step 91, recording a first pixel position A1 and a second pixel position A2 on the CCD/CMOS respectively related to centers of spot marks directly emitted by any two of light emitting devices, when a mobile electronic device is moved to a first position R1 of a map, thus obtaining distance of each pixel according to a map coordinate system as (A2−A1)/L, wherein (A2−A1) represents number of pixels between A2 and A1, and L represents distance between the two light emitting devices according to the map coordinate system; recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2; and

step 92, correcting step: moving the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two light emitting devices, so as to obtain deviation distance of the mobile electronic device according to the map coordinate system as L_{deviation} (A3−A1)*(A2−A1)/L; and recording angle α2 between the pixel position A3 and the fourth pixel position A4, so as to obtain deviation angle α_{deviation}=α2−α1; correcting coordinate values of the constructed map based on the deviation distance L_{deviation} and the deviation angle α_{deviation}.

The angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

wherein x2 and y2 are respectively pixel differences of a line segment formed by the third pixel position A3 and the forth pixel position A4 on the X-axis and the Y-axis of the CCD/CMOS.

Preferably, in the present embodiment, the mobile electronic is robot.

As can be understood, the map is constructed with any one of methods for map constructing based on light-emitting device according to embodiment 1 to embodiment 4.

The operation principle and working process of the apparatus for map correcting according to the present embodiment can be referred to the embodiment 4, which will not be repeated thereto.

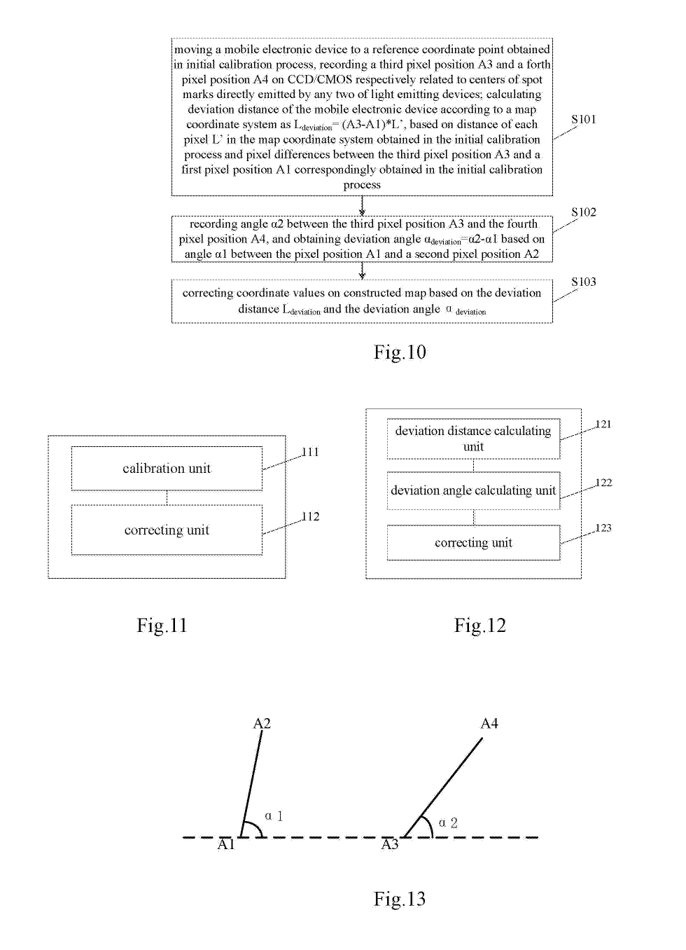

Referring to FIG. 10, it is a flowchart of a method for map correcting based on light-emitting device according to embodiment 10 of the present invention. The method comprises:

step 101, moving a mobile electronic device to a reference coordinate point obtained in initial calibration process, recording a third pixel position A3 and a forth pixel position A4 on CCD/CMOS respectively related to centers of spot marks directly emitted by any two of light emitting devices; calculating deviation distance of the mobile electronic device according to a map coordinate system as L_{deviation}(A3−A1)*L′, based on distance of each pixel L′ in the map coordinate system obtained in the initial calibration process and pixel differences between the third pixel position A3 and a first pixel position A1 correspondingly obtained in the initial calibration process;

step 102, recording angle α2 between the third pixel position A3 and the fourth pixel position A4, and obtaining deviation angle α_{deviation}=α2−α1 based on angle α1 between the pixel position A1 and a second pixel position A2; and

step 103, correcting coordinate values on constructed map based on the deviation distance L_{deviation} and the deviation angle α_{deviation}.

The initial calibration process is as follows:

(1) recording the first pixel position A1 and the second pixel position A2 on the CCD/CMOS respectively related to the centers of the spot marks directly emitted by any two of light emitting devices, when the mobile electronic device is moved to a first position R1 of a map;

(2) calculating distances of each pixel according to the map coordinate system as L′=(A2−A1)/L, wherein (A2−A1) represents number of pixels between A1 and A2, L represents distances of the two of light emitting devices according to the map coordinate system;

(3) recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2.

The angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

wherein x2 and y2 are respectively pixel differences of a line segment formed by the third pixel position A3 and the forth pixel position A4 on the X-axis and the Y-axis of the CCD/CMOS.

Preferably, in the present embodiment, the mobile electronic is a robot.

As can be understood, the map is constructed with any one of methods for map constructing based on light-emitting device according to embodiment 1 to embodiment 4.

The operation principle and working process of the apparatus for map correcting according to the present embodiment can be referred to the embodiment 4, which will not be repeated thereto.

Referring to FIG. 11, it is composition block diagram of an apparatus for map correcting based on light-emitting device, wherein the apparatus comprises:

a calibration unit 111, configured to record a first pixel position A1 and a second pixel position A2 on the CCD/CMOS respectively related to the centers of the spot marks directly emitted by any two of light emitting devices, when the mobile electronic device is moved to a first position R1 of the map, thus obtaining distance of each pixel according to a map coordinate system as (A2−A1)/L, wherein (A2−A1) represents the number of pixels between A2 and A1, and L represents distance between the two light emitting devices according to the map coordinate system; record coordinate values of the first position R1 of the mobile electronic device according to the map coordinate system and coordinate values of the two pixel positions on the CCD/CMOS respectively related to the centers of the spot marks directly emitted by the two of light emitting devices, and record angle α1 between the pixel position A1 and the second pixel position A2; and

a correcting unit 112, configured to move the mobile electronic device to the first position R1 when the map needs to be corrected at any time after the map is constructed, record a third pixel position A3 and a forth pixel position A4 on the CCD/CMOS respectively related to the centers of the spot marks directly emitted by the two light emitting devices, so as to obtain deviation distance of the mobile electronic device according to the map coordinate system as L_{deviation} (A3−A1)*(A2−A1)/L; and record angle α2 between the pixel position A3 and the fourth pixel position A4, so as to obtain deviation angle α_{deviation}=α2−α1; correct coordinate values on the constructed map based on the deviation distance L_{deviation} and the deviation angle α_{deviation}.

The angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

wherein x2 and y2 are respectively pixel differences of a line segment formed by the third pixel position A3 and the forth pixel position A4 on the X-axis and the Y-axis of the CCD/CMOS.

Preferably, in the present embodiment, the mobile electronic is a robot.

As can be understood, the map is constructed by any one of apparatuses for map constructing based on light-emitting device according to embodiment 5 to embodiment 8.

Referring to FIG. 12, it is composition block diagram of an apparatus for map correcting based on light-emitting device according to embodiment 12, wherein the apparatus comprises:

a deviation distance calculating unit 121, configured to move a mobile electronic device to a reference coordinate point obtained in initial calibration process, recording a third pixel position A3 and a forth pixel position A4 on CCD/CMOS respectively related to centers of spot marks directly emitted by any two of light emitting devices; calculate deviation distance of the mobile electronic device according to a map coordinate system as L_{deviation}=(A3−A1)*L′, based on distance of each pixel in the map coordinate system obtained by the initial calibration process and pixel differences between the third pixel position A3 and a first pixel position A1 obtained in the initial calibration process;

a deviation angle calculating unit 122, configured to record angle α2 between the third pixel position A3 and the fourth pixel position A4, and obtaining deviation angle α_{deviation}=α2−α1 based on angle α1 between the pixel position A1 and a second pixel position A2; and

a correcting unit 123, configured to correct coordinate values on constructed map based on the deviation distance L_{deviation} and the deviation angle α_{deviation}.

The initial calibration process is as follows:

recording the first pixel position A1 and the second pixel position A2 on the CCD/CMOS respectively related to the centers of the spot marks directly emitted by any two of light emitting devices, when the mobile electronic device is moved to a first position R1 of a map;

calculating distances of each pixel according to the map coordinate system as L′=(A2−A1)/L, wherein (A2−A1) represents number of pixels between A1 and A2, L represents distances of the two of light emitting devices according to the map coordinate system; and

recording coordinate values of the first position R1 of the mobile electronic device according to the map coordinate system and coordinate values of the two pixel positions on the CCD/CMOS respectively related to the centers of the spot marks directly emitted by the two of light emitting devices, and recording angle α1 between the pixel position A1 and the second pixel position A2.

The angle α1 and the angle α2 are calculated by the following equations:

α1=arc tan(y1/x1);

α2=arc tan(y2/x2);

wherein x1 and y1 are respectively pixel differences of a line segment formed by the first pixel position A1 and the second pixel position A2 on X-axis and Y-axis of the CCD/CMOS;

x2 and y2 are respectively pixel differences of a line segment formed by the third pixel position A3 and the forth pixel position A4 on the X-axis and the Y-axis of the CCD/CMOS.

Preferably, in the present embodiment, the mobile electronic is a robot.

As can be understood, the map is constructed by any one of apparatuses for map constructing based on light-emitting device according to embodiment 5 to embodiment 8.

The operation principle and working process of the apparatus for map correcting according to the present embodiment can be referred to the embodiment 4, which will not be repeated thereto.

Finally, it should be noted as well that the above-mentioned series of processing includes not only the processing performed according to time sequence in the order described herein, but also the processing performed in parallel or separately, rather than in chronological order. With the description of the above embodiments, it will be apparent to persons having ordinary skill in the art that the present invention may be implemented by means of software and necessary hardware platforms, and may be implemented only by software for sure. Based on this understanding, all or parts of the technical solution of the present invention that contributes to the background art may be embodied in the form of software product, which can be stored in a storage medium such as ROM/RAM, magnetic disk, optical disk and so on, which is including a number of instructions for enabling a computer device (which may be a personal computer, a server, or a network device and so on) to perform the methods described in certain parts of the embodiments or each embodiment of the present invention.

The foregoing descriptions are merely exemplary embodiments of the present invention, but are not intended to limit the present disclosure. Any modifications, equivalent substitutions, and improvements made by those skilled in the art within the spirit and principle of the present disclosure shall fall within the protection scope of the present disclosure.

What is claimed is:

1. A method for map constructing based on light-emitting device, wherein the method is applicable for real-time mapping of a to-be-localized area, upper part of the to-be-localized area is provided with light-emitting device and the method comprises steps of:
taking a position of a mobile electronic device which is moving along a certain trajectory as a coordinate origin of a map coordinate system, when a center of a spot mark directly emitted by a first light-emitting device and collected by a camera of a mobile electronic device coincides with central point of CCD/CMOS, and recording information of the spot mark of the first light-emitting device and corresponding coordinate values;
moving the mobile electronic device with the coordinate origin as a starting point to traverse the entire to-be-localized area, calculating and recording coordinate values of a position of one of obstacles each time when it is detected by the mobile electronic device based on a moving direction and a moving distance of the mobile electronic device relative to the starting point during the traversing process;
constructing a map based on recorded information of spot mark and corresponding coordinate values and the coordinate values of the position of each said obstacle after the traversing process is finished.

2. The method for map constructing based on light-emitting device according to claim 1, wherein the number of light-emitting devices is two or more, and each said light-emitting device is respectively disposed at a specific position in the upper part of the to-be-localized area, and the information of the spot mark directly emitted by each said light-emitting device includes unique encoding information for distinguishing its absolute position; the method further comprises step of:
calculating coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, recording information of the spot mark of the other light-emitting device and corresponding coordinate values.

3. The method for map constructing based on light-emitting device according to claim 2, wherein the unique encoding information is represented by any one of the following ways or combinations:
number of emitting lights of a light-emitting device;
specific shape formed by emitting lights of a light-emitting device;
number of times for turning on and off a light emitting device within a certain period of time;
time for turning on and off a light emitting device within a certain period of time; or
combination of emitting lights with different colors of a light-emitting device.

4. The method for map constructing based on light-emitting device according to claim 2, wherein the information of the spot mark emitted by any one of light-emitting devices further comprises area coding information used for limiting moving range; the method further comprises:
controlling the mobile electronic device to move within the moving range when the mobile electronic device obtains the area coding information used for limiting moving range.

5. The method for map constructing based on light-emitting device according to claim 2, wherein the method further comprises:
calibration process: recording a first pixel position A1 and a second pixel position A2 on the CCD/CMOS respectively related to the centers of the spot marks directly emitted by any two of the light emitting devices, when the mobile electronic device is moved to a first position R1 of the map, thus obtaining distance of each pixel according to a map coordinate system as (A2−A1)/L, wherein (A2−A1) represents number of pixels between A2 and A1, and L represents distance between the two light emitting devices according to the map coordinate system; recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2; and
correcting process: moving the mobile electronic device to the first position R1 when the map needs to be corrected at any time after the map is constructed, recording a third pixel position A3 and a forth pixel position A4 on the CCD/CMOS respectively related to the centers of the spot marks directly emitted by the two of light emitting devices, so as to obtain deviation distance of the mobile electronic device according to the map coordinate system as L_{deviation}=(A3−A1)*(A2−A1)/L; and recording angle α2 between the pixel position A3 and the fourth pixel position A4, so as to obtain deviation angle α_{deviation}=α2−α1; correcting coordinate values of the constructed map based on the deviation distance L_{deviation} and the deviation angle α_{deviation}.

6. The method for map constructing based on light-emitting device according to claim 5, wherein the angle α1 and the angle α2 are calculated by the following equations:
α1=arc tan(y1/x1);
α2=arc tan(y2/x2);
wherein x1 and y1 are respectively pixel differences of a line segment formed by the first pixel position A1 and the second pixel position A2 on X-axis and Y-axis of the CCD/CMOS;
x2 and y2 are respectively pixel differences of a line segment formed by the third pixel position A3 and the forth pixel position A4 on the X-axis and the Y-axis of the CCD/CMOS.

7. The method for map constructing based on light-emitting device according to claim 1, wherein the mobile electronic device is a robot.

8. The method for map constructing based on light-emitting device according to claim 1, wherein the method is applicable for real-time map constructing of indoor to-be-localized area; or/and the light-emitting device is suitable to be mounted on wall, ceiling or doorframe.

9. A method for map correcting based on light-emitting device, wherein the method comprises:
moving a mobile electronic device to a reference coordinate point obtained in initial calibration process, recording a third pixel position A3 and a forth pixel position A4 on CCD/CMOS respectively related to centers of spot marks directly emitted by any two of light emitting devices; calculating deviation distance of the mobile electronic device according to a map coordinate system as L_{deviation}=(A3−A1)*L′, based on distance of each pixel L′ in the map coordinate system obtained in the initial calibration process and pixel differences between the third pixel position A3 and a first pixel position A1 correspondingly obtained in the initial calibration process;
recording angle α2 between the third pixel position A3 and the fourth pixel position A4, and obtaining deviation angle α_{deviation}=α2−α1 based on angle α1 between the pixel position A1 and a second pixel position A2; and
correcting coordinate values on constructed map based on the deviation distance L_{deviation} and the deviation angle α_{deviation}.

10. The method for map correcting according to claim 9, wherein the initial calibration process is as follows:
recording the first pixel position A1 and the second pixel position A2 on the CCD/CMOS respectively related to the centers of the spot marks directly emitted by any two of light emitting devices, when the mobile electronic device is moved to a first position R1 of a map;
calculating distances of each pixel according to the map coordinate system as L′=(A2−A1)/L, wherein (A2−A1) represents number of pixels between A1 and A2, L represents distances of the two of light emitting devices according to the map coordinate system; and
recording coordinate values of the first position R1 of the mobile electronic device according to the map coordinate system and coordinate values of the two pixel positions on the CCD/CMOS respectively related to the centers of the spot marks directly emitted by the two light emitting devices, and recording angle α1 between the pixel position A1 and the second pixel position A2.

11. The method for map correcting according to claim 9, wherein the angle α1 and the angle α2 are calculated by the following equations:
α1=arc tan(y1/x1);
α2=arc tan(y2/x2);
wherein x1 and y1 are respectively pixel differences of a line segment formed by the first pixel position A1 and the second pixel position A2 on X-axis and Y-axis of the CCD/CMOS; and
x2 and y2 are respectively pixel differences of a line segment formed by the third pixel position A3 and the forth pixel position A4 on the X-axis and the Y-axis of the CCD/CMOS.

12. The method for map correcting according to claim 11, wherein the light-emitting devices are LED source, laser source or infrared source.

13. An apparatus for map constructing based on light-emitting device, wherein the apparatus is applicable for real-time mapping of a to-be-localized area, upper part of the to-be-localized area is provided with light-emitting device, the apparatus is a mobile electronic device and the apparatus comprises:
a camera, configured to collect spot mark directly emitted by light-emitting device;
a coordinate system constructing and recording unit, configured to take a position of a mobile electronic which is moving along a certain trajectory as a coordinate origin of a map coordinate system, when a center of a spot mark emitted by a first light-emitting device and collected by the camera of the mobile electronic device coincides with central point of CCD/CMOS, and record information of the spot mark of the first light-emitting device and corresponding coordinate values;
an encoder, configured to record a moving distance and a moving direction of the mobile electronic device relative to a starting point in real time through gyroscope when the mobile electronic device traverses the entire to-be-localized area with the coordinate origin as the starting point;
an obstacle detecting unit, configured to detect obstacles;
a first calculating unit, configured to calculate coordinate values of the location of each said obstacle based on the moving direction and the moving distance of the mobile electronic device relative to the starting point recorded by the encoder when the mobile electronic device detects any one of the obstacle, and send the calculated coordinate values to the coordinate system constructing and recording unit; and
a map constructing unit, configured to construct a map according to information of spot mark and corresponding coordinate values and the coordinate values of the location of each said obstacle recorded by the coordinate system constructing and recording unit.

14. The apparatus for map correcting according to claim 13, wherein the number of light-emitting devices is two or more, and each said light-emitting device is respectively disposed at a specific position in the upper part of the to-be-localized area, and the information of the spot mark directly emitted by each said light-emitting device includes unique encoding information for distinguishing its absolute position; the apparatus further comprises:
a second calculating unit, configured to coordinate values of other light-emitting device except the first light-emitting device based on a moving direction and a moving distance of the mobile electronic device relative to the starting point during the traversing process, when a center of a spot mark directly emitted by the other light-emitting device and collected by the camera of the mobile electronic device coincides with the central point of the CCD/CMOS, and send information of the spot mark of the other light-emitting device and corresponding coordinate values to the coordinate system constructing and recording unit;

15. The apparatus for map correcting according to claim 14, wherein the unique encoding information is represented by any one of the following ways or combinations:
number of emitting lights of a light emitting device;
specific shape formed by emitting lights of a light emitting device;
number of times for turning on and off a light emitting device within a certain period of time;
time for turning on and off a light emitting device within a certain period of time; or
combination of emitting lights with different colors of a light emitting device.

16. The apparatus for map correcting according to claim 14, wherein the apparatus further comprises:
calibration unit, configured to record a first pixel position A1 and a second pixel position A2 on the CCD/CMOS respectively related to the centers of the spot marks directly emitted by any two of light emitting devices, when the mobile electronic device is moved to a first position R1 of the map, thus obtaining distance of each pixel according to a map coordinate system as (A2−A1)/L, wherein (A2−A1) represents the number of pixels between A2 and A1, and L represents distance between the two light emitting devices according to the map coordinate system; record coordinate values of the first position R1 of the mobile electronic device according to the map coordinate system and coordinate values of the two pixel positions on the CCD/CMOS respectively related to the centers of the spot marks directly emitted by the two of light emitting devices, and record angle α1 between the pixel position A1 and the second pixel position A2; and
correcting unit, configured to move the mobile electronic device to the first position R1 when the map needs to be corrected at any time after the map is constructed, record a third pixel position A3 and a forth pixel position A4 on the CCD/CMOS respectively related to the centers of the spot marks directly emitted by the two light emitting devices, so as to obtain deviation distance of the mobile electronic device according to the map coordinate system as L_{deviation} (A3−A1)*(A2−A1)/L; and record angle α2 between the pixel position A3 and the fourth pixel position A4, so as to obtain deviation angle α_{deviation}=α2−α1; correct coordinate values on the constructed map based on the deviation distance L_{deviation} and the deviation angle α_{deviation}.

17. The apparatus for map correcting according to claim 16, wherein the angle α1 and the angle α2 are calculated by the following equations:
α1=arc tan(y1/x1);
α2=arc tan(y2/x2);
wherein x1 and y1 are respectively pixel difference of a line segment formed by the first pixel position A1 and the second pixel position A2 on X-axis and Y-axis of the CCD/CMOS; and
x2 and y2 are respectively pixel difference of a line segment formed by the third pixel position A3 and the forth pixel position A4 on the X-axis and the Y-axis of the CCD/CMOS.

18. An apparatus for map correcting based on light-emitting device, wherein the apparatus comprises:
deviation distance calculating unit, configured to move a mobile electronic device to a reference coordinate point obtained in initial calibration process, recording a third pixel position A3 and a forth pixel position A4 on CCD/CMOS respectively related to centers of spot marks directly emitted by any two of light emitting devices; calculate deviation distance of the mobile electronic device according to a map coordinate system as L_{deviation}=(A3−A1)*L′, based on distance of each pixel in the map coordinate system obtained by the initial calibration process and pixel differences between the third pixel position A3 and a first pixel position A1 obtained in the initial calibration process;
deviation angle calculating unit, configured to record angle α2 between the third pixel position A3 and the fourth pixel position A4, and obtaining deviation angle α_{deviation}=α2−α1 based on angle α1 between the pixel position A1 and a second pixel position A2; and
correcting unit, configured to correct coordinate values on constructed map based on the deviation distance L_{deviation} and the deviation angle α_{deviation}.

19. The apparatus for map correcting based on light-emitting device according to claim 18, wherein the initial calibration process is as follows:
recording the first pixel position A1 and the second pixel position A2 on the CCD/CMOS respectively related to the centers of the spot marks directly emitted by any two of light emitting devices, when the mobile electronic device is moved to a first position R1 of a map;
calculating distances of each pixel according to the map coordinate system as L′=(A2−A1)/L, wherein (A2−A1) represents number of pixels between A1 and A2, L represents distances of the two of light emitting devices according to the map coordinate system; and
recording coordinate values of the first position R1 of the mobile electronic device according to the map coordinate system and coordinate values of the two pixel positions on the CCD/CMOS respectively related to the centers of the spot marks directly emitted by the two of light emitting devices, and recording angle α1 between the pixel position A1 and the second pixel position A2.

20. The apparatus for map correcting based on light-emitting device according to claim 18, wherein the angle α1 and the angle α2 are calculated by the following equations:
α1=arc tan(y1/x1);
α2=arc tan(y2/x2);
wherein x1 and y1 are respectively pixel difference of a line segment formed by the first pixel position A1 and the second pixel position A2 on X-axis and Y-axis of the CCD/CMOS; and
x2 and y2 are respectively pixel difference of a line segment formed by the third pixel position A3 and the forth pixel position A4 on the X-axis and the Y-axis of the CCD/CMOS.
